(19) United States
(12) Patent Application Publication
(10) Pub. No.: US 2005/0063416 A1
(43) Pub. Date: Mar. 24, 2005

(54) Apparatus and method for constructing ad-hoc network of heterogeneous terminals

(75) Inventors: Sang-hyun Shin, Suwon-si (KR); Hak-goo Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/886,164

(22) Filed: Jul. 8, 2004

(30) Foreign Application Priority Data
Jul. 11, 2003 (KR) 2003-47410

(51) Int. Cl. H04Q 7/24; H04B 7/00; H04J 3/22; H04J 3/16

(52) U.S. Cl. 370/465; 370/310

(57) ABSTRACT

An apparatus and method for enabling communications between heterogeneous terminals are provided. A method for establishing an ad-hoc network includes: accessing a first terminal, on which a first protocol stack is installed; accessing a second terminal, on which a second protocol stack is installed; receiving a data packet, formatted for the first protocol stack, from the first terminal; converting the format of the data packet to the format of the second protocol stack; and transmitting the converted data packet to the second terminal. The apparatus and method enable a plurality of heterogeneous terminals, conventionally unable to communicate directly with each other, to form an ad-hoc network in which they can freely communicate with each other.

This application claims the priority of Korean Patent Application No. 2003-47410, filed on Jul. 11, 2003, in the Korean Intellectual Property Office, the disclosure of which is incorporated herein in its entirety by reference.

### BACKGROUND OF THE INVENTION

1. Field of the Invention

The present invention relates to an apparatus and method enabling communications between heterogeneous terminals, and more particularly, to an apparatus and method enabling communications between wireless LAN terminals and Bluetooth terminals.

2. Discussion of Related Art

Since the introduction of the Internet, the world has become increasingly networked. With the recent development of wireless technologies, wireless Internet, using a variety of technologies, such as a code division multiple access (CDMA), wireless LAN, infrared data association (IrDA) technology, and Bluetooth technology, have also been developed and widely used by ordinary users. In addition, through the use of a wireless communication method, homogeneous terminals can be connected to each other to form an ad-hoc network without being connected to the Internet. In such a case, each wireless communication method uses its own protocol stack and because of this, there is the problem that terminals using heterogeneous communication methods cannot communicate with each other.

The prior art wireless local area network (LAN) protocol stack and the prior art Bluetooth protocol stack will now be reviewed with reference to attached drawings.

FIG. 1 is a diagram of the structure of a prior art wireless LAN protocol stack.

Referring to FIG. 1, the wireless LAN protocol stack is hierarchically constructed from the bottom layer in order of a radio frequency (RF) layer 11, a 802.11a/b media access control (MAC) layer 12, a logical link control (LLC) layer 13, an Internet protocol (IP) layer 14, a transmission control protocol (TCP)/user datagram protocol (UDP) layer 15, and a socket layer 16.

The RF layer 11 corresponds to the physical layer that is the lowest layer in the open systems interconnection (OSI) reference model, and 802.11a uses the 5 GHz band, while 802.11b uses the 2.4 GHz band. Binary phase shift keying (BPSK), quadrature phase shift keying (QPSK), 16-quadrature amplitude modulation (QAM), and 64-orthogonal frequency division multiplexing (OFDM) are used as modulation methods.

The 802.11 a/b MAC layer 12 corresponds to the lower layer of two sub layers of the data link layer of the OSI reference model and is a protocol for a plurality of terminals sharing a transmission channel to efficiently use the shared transmission channel. The 802.11 is a set of standards for a wireless LAN developed by an IEEE working group. All 802.11 standards use carrier sense multiple access (CSMA)/collision avoidance (CA), which is an Ethernet protocol, to share a channel.

Since a MAC address is allocated to a product with a unique number in the world when the product is shipped from a manufacturer, it can be said to be the address of a hardware device. In an Ethernet that is an ordinary LAN, all terminals connected in a single LAN segment can communicate with upper layer protocols such as TCP/IP, based on their MAC addresses.

The LLC layer 13 corresponds to the upper layer of the two sub layers in the data link layer in the OSI reference model and processes error control, flow control, frame handling, and MAC sub layer addressing.

The IP layer 14 corresponds to the network layer in the OSI reference model and is a protocol used in transmitting data from one terminal to another terminal on the Internet. Each terminal on the Internet has at least one or more unique addresses such that it can be distinguished from other terminals. When a user transmits or receives data such as email or a web page, the data is divided into predetermined small pieces referred to as packets. Each of these packets includes the IP address of a transmitting terminal and the IP address of a receiving terminal.

Since the data is divided into a plurality of packets, each packet may be transmitted through a different route, and may arrive in an order different from the order of transmission. This is handled by another protocol, the TCP. The TCP layer 15 corresponds to the transport layer in the OSI reference model and is a protocol which rearranges the packets into the correct order.

The UDP layer 15 corresponds to the transport layer in the OSI reference model as a TCP layer 15, and is a protocol which provides limited services when data is exchanged between terminals in a network using an IP. Unlike a TCP layer, however, a UDP layer does not provide services such as dividing a message into packets (datagrams), or recombining, and rearranging arriving data packets. That is, an application program using the UDP should confirm that the entire message has arrived in correct order.

The socket layer 16 corresponds to the application layer that is the highest layer in the OSI reference model, and is a communication method between a client program and a server program on a network.

FIG. 2 is a diagram illustrating a structure of a prior art Bluetooth protocol stack.

Referring to FIG. 2, the Bluetooth protocol stack is hierarchically constructed from the bottom layer in order of an RF layer 21, a baseband layer 22, a host controller interface (HCI) layer 23, a logical link control and adaptation protocol (L2CAP) layer 24, a service discovery protocol (SDP) layer 25, a Bluetooth network encapsulation protocol (BNEP) layer 26, an IP layer 27, a TCP/UDP layer 28, and a socket layer 29.

The RF layer 21 corresponds to the physical layer that is the lowest layer of the OSI reference model, and performs 1,600 times frequency hopping of 79 channels normally with a 1 mW output and 1 MHz bandwidth in an industrial, scientific, medical (ISM) band of 2.4-2.4835 GHz that does not require a license. The modulation method is a Gaussian frequency shift keying (G-FSK), and for duplex communication, a time division duplex (TDD) method is used.

The baseband layer 22 corresponds to the physical layer that is the lowest layer in the OSI reference model as the RF layer. Seven Bluetooth terminals are connected to one piconet. One of the seven terminals becomes a master which manages the piconet, and performs tasks such as generation of frequency hopping patterns. The remaining terminals are connected to the master terminal as slaves.

The HCI layer 23 corresponds to the data link layer of the OSI reference model and is a protocol acting as a relay and connecting a Bluetooth terminal and a host. The reason why a Bluetooth standard includes an interface method as the HCI is that, by completely dividing hardware and software, when the Bluetooth hardware module of a product is replaced, software does not need to be replaced as well.

The L2CAP layer 24 corresponds to the data link layer in the OSI reference model and is a protocol for interfacing a lower protocol stack and an upper application. The L2CAP performs a role similar to the TCP of the Internet protocol.

The L2CAP layer 24 is placed immediately above the HCI layer 23 and allows an upper protocol or application to exchange a data packet of up to 64 MB.

The BNEP layer 26 corresponds to the data link layer in the OSI reference model and is a protocol for transmitting control packets and data packets between Bluetooth terminals. A personal area network (PAN) profile is a rule to transfer IP traffic between Bluetooth terminals. An Ethernet packet is encapsulated in an L2CAP packet by using the BNEP. A Bluetooth terminal is connected to another Bluetooth terminal in order to form an ad-hoc network. At this time, a search according to baseband inquiry and the SDP 25 is performed. However, before this, Bluetooth terminals should register services provided by the terminals with a service discovery (SD) database. Once connected, the Bluetooth terminal generates an L2CAP channel for the BNEP, uses BNEP commands to initialize the BNEP connection, and sets filtering for other network packet types. The remaining layers, the IP 27, TCP/UDP 28, and socket 29 layers, are the same as those in the wireless LAN, and their explanation will be omitted.

As described above, the conventional wireless LAN terminal has a protocol stack for wireless LAN communications, and the conventional Bluetooth terminal has a protocol stack for Bluetooth communications. That is, a wireless LAN terminal forms an ad-hoc network with other wireless LAN terminals based on the wireless LAN protocol stack, while a Bluetooth terminal forms an ad-hoc network with other Bluetooth terminals based on the Bluetooth protocol stack. Accordingly, in conventional technology, there is a problem that in the case of a terminal on which a Bluetooth module is installed, the terminal can communicate only with another terminal on which a Bluetooth module is installed, and in the case of a terminal on which a wireless LAN module is installed, the terminal can communicate only with another terminal on which a wireless LAN module is installed. Also, since conventional communication between a Bluetooth terminal and a wireless LAN terminal is impossible, there is a problem that an ad-hoc network including a Bluetooth terminal and a wireless LAN terminal, that are heterogeneous terminals, cannot be established.

### SUMMARY OF THE INVENTION

The present invention provides an apparatus and method by which communication between heterogeneous terminals that cannot conventionally communicate with each other is enabled, and also provides an ad-hoc network in which a plurality of heterogeneous terminals can freely communicate with each other and an apparatus and method enabling communication between a wireless LAN terminal and a Bluetooth terminal that are representative heterogeneous terminals.

According to one aspect of the present invention, there is provided a method of establishing an ad-hoc network including: accessing a first terminal on which a first protocol stack is installed; accessing a second terminal on which a second protocol stack is installed; receiving a data packet, formatted for the first protocol stack, from the first terminal; converting the format of the received data packet to the format of the second protocol stack; and transmitting the converted data packet to the second terminal.

According to another aspect of the present invention, there is provided a method of communication between heterogeneous protocols including: receiving a data packet at the lowest layer in a first protocol stack; transferring the received data packet to a conversion layer; and converting a first protocol packet format of the data packet transferred to the conversion layer into a second protocol packet format.

According to still another aspect of the present invention, there is provided a mixed protocol stack including: a single layer portion which is obtained by unifying upper layers common to a first protocol stack and a second protocol stack; a double layer portion which is obtained by separating lower layers different in the first protocol stack and in the second protocol stack; and a conversion layer which converts format between a first protocol packet format and a second protocol packet format and which is disposed between the single layer portion and the double layer portion.

According to still another aspect of the present invention, there is provided a computer readable recording medium having embodied thereon a computer program for the above-mentioned method of establishing an ad-hoc network.

According to still another aspect of the present invention, there is provided a computer readable recording medium having embodied thereon a computer program for the above-mentioned method of communicating between heterogeneous protocols.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of the structure of a prior art wireless LAN protocol stack;

FIG. 2 is a diagram of the structure of a prior art Bluetooth protocol stack;

FIG. 3 is a diagram of the structure of a wireless LAN/Bluetooth mixed protocol stack according to an embodiment of the present invention;

FIG. 4 is a diagram showing the format of a packet complying with IEEE 802.11 standards;

FIG. 5 is a diagram showing the format of a packet complying with Bluetooth standards;

FIG. 6 is a diagram of the structure of an apparatus for establishing an ad-hoc network according to an embodiment of the present invention;

FIG. 7 is a diagram of the structure of a wireless LAN→Bluetooth communication apparatus according to an embodiment of the present invention;

FIG. 8 is a diagram of the structure of a Bluetooth→wireless LAN communication apparatus according to an embodiment of the present invention;

FIG. 9 is a diagram showing an implemented model of a wireless LAN/Bluetooth mixed terminal according to an embodiment of the present invention;

FIGS. 10A and 10B are flowcharts of the steps performed according to a method for establishing an ad-hoc network according to an embodiment of the present invention;

FIG. 11 is a flowchart of the steps performed according to a method for wireless LAN→Bluetooth communications according to an embodiment of the present invention; and

FIG. 12 is a flowchart of the steps performed according to a method for Bluetooth→wireless LAN communications according to an embodiment of the present invention.

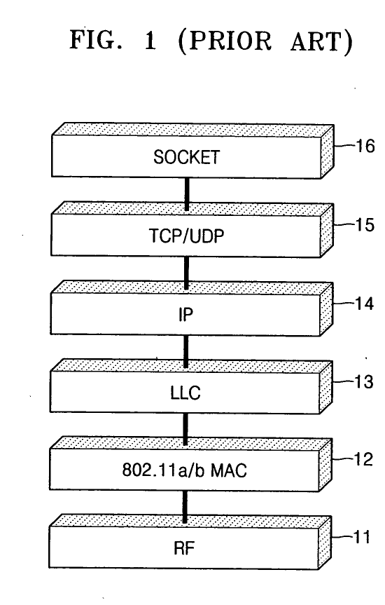

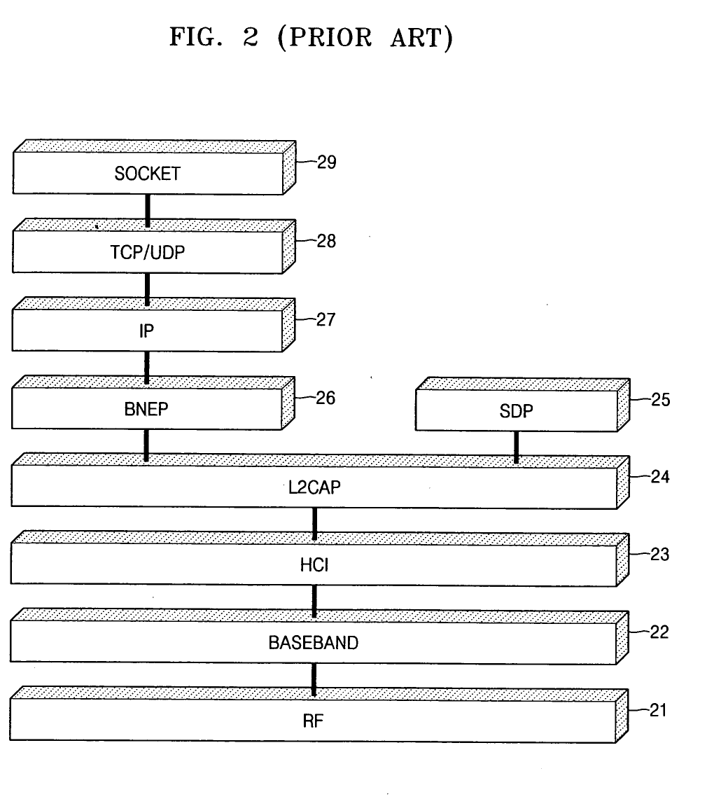

### DETAILED DESCRIPTION OF THE INVENTION

The present invention will now be described more fully with reference to the accompanying drawings, in which exemplary embodiments of the invention are shown.

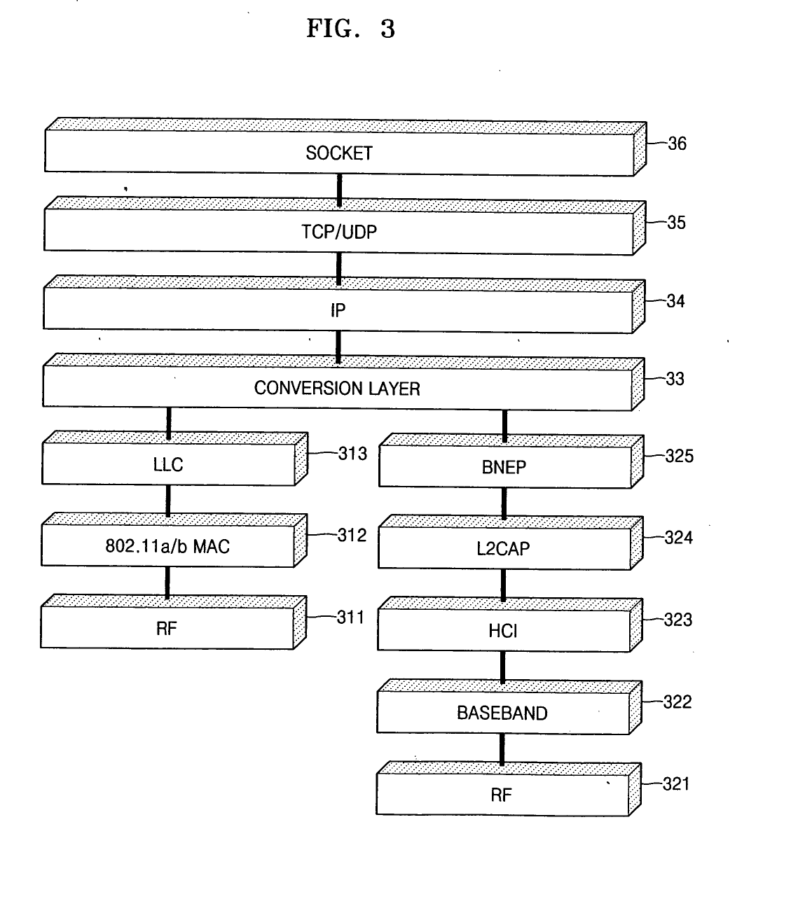

Referring to FIG. 3, the wireless LAN/Bluetooth mixed protocol stack is constructed hierarchically in order of an RF layer 311, a 802.11a/b media access control (MAC) layer 312, and a logical link control (LLC) layer 313 from the left-hand side bottom layer, and in order of a RF layer 321, a baseband layer 322, a host controller interface (HCI) layer 323, a logical link control and adaptation protocol (L2CAP) layer 324, and a Bluetooth network encapsulation protocol (BNEP) layer 325 from the right-hand side bottom layer. Then, conversion layer 33, IP 34, TCP/UDP 35, and socket 36 are constructed in order over the LLC 313 and BNEP 325.

The wireless LAN/Bluetooth mixed protocol stack unifies upper layers common to the wireless LAN protocol stack and the Bluetooth protocol stack, into a number of single layers which will be referred to as a single layer portion. That is, the single layer portion is constructed from a bottom layer in order of an IP layer 34, a TCP/UDP layer 35, and a socket layer 36.

The wireless LAN/Bluetooth mixed protocol stack separates the lower layers of the wireless LAN protocol stack and of the Bluetooth protocol stack, which differ from each other, into two different hierarchies (a left-hand side branch including the lower layers of the wireless LAN protocol stack, and a right-hand side branch including the lower layers of the Bluetooth protocol stack) which will be referred to as a double layer portion. That is, the double layer portion is divided into a Bluetooth protocol stack side and a wireless LAN protocol stack side. In the wireless LAN protocol stack side, an RF layer 311, a 802.11a/b MAC layer 312, and a LLC layer 313 are stacked in order from the bottom, while in the Bluetooth protocol stack side, an RF layer 31, a baseband layer 322, an HCI layer 323, an L2CAP layer 324, and a BNEP layer 325 are stacked in order from the bottom.

The wireless LAN/Bluetooth mixed protocol stack includes a conversion layer 33 for converting a wireless LAN packet format into a Bluetooth packet format and vice versa, between the single layer and the double layer.

The main reason why communication between a wireless LAN terminal and a Bluetooth terminal cannot be performed with conventional technology is that formats of the wireless LAN standard and the Bluetooth standard are different from each other and even if a packet is received from one by the other, the packet cannot be recognized and therefore, cannot be processed internally.

To solve this problem, the conversion layer converts a packet format complying with the wireless LAN standard into a packet format complying with the Bluetooth standard, and vice versa. Hereinafter, the packet format complying with the wireless LAN standard will be referred to as a wireless LAN packet format, and the packet format complying with the Bluetooth standard will be referred to as a Bluetooth packet format.

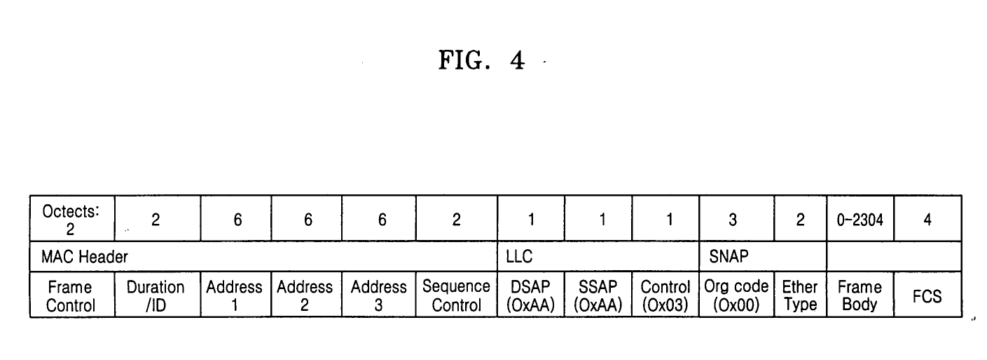

FIG. 4 is a diagram showing the format of a packet complying with IEEE 802.11 standards (wireless LAN standards).

Referring to FIG. 4, a packet complying with IEEE 802.11 standards includes a frame control field, a duration/ID field, an address 1 field, an address 2 field, an address 3 field, a sequence control field, a destination service access point (DSAP) field, a source service access point (SSAP) field, a control field, an organization code field, an ether type field, a frame body field, and a frame check sequence (FCS) field. The frame control field, the duration/ID field, the address 1 field, the address 2 field, the address 3 field, and the sequence control field are those fields related to a MAC header. A destination address is written in address 1 field, and a source address is written in address 2 field. The DSAP field, the SSAP field, and the control field relate to LLC, and the organization code field and the ether type field relate to subnetwork access protocol (SNAP). The type of an Ethernet packet is written in ether type field. In frame body field, actual data desired to be transmitted by a user are written. The FCS field is a field to check an error in all fields except the FCS field, by performing cyclic redundancy checking (CRC).

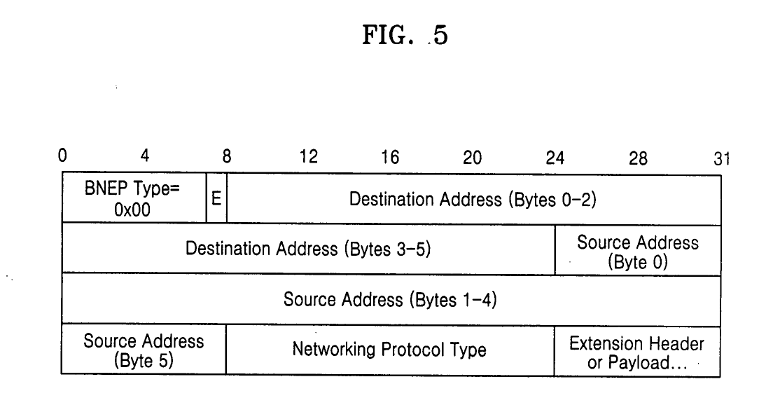

FIG. 5 is a diagram showing the format of a packet complying with Bluetooth standard.

Referring to FIG. 5, the packet complying with the Bluetooth standard includes a BNEP type field, an extension field E, a destination address field, a source address field, a networking protocol type field, and a payload field. In front of the payload field, an extension header field may be added.

In the BNEP type field, the type of BNEP header is written. In the extension field, whether or not one or more extension header fields will be added in front of the payload field is written. A destination address is written in the destination address field; a source address is written in the source address field; the type of a networking protocol is written in the networking protocol type field; and actual data desired to be transmitted by a user are written in the payload field. According to the Bluetooth standard, a value matching the type of an Ethernet packet is written in the networking protocol type field.

The conversion layer converts the source address field of the Bluetooth packet format into the source address field (the address 2 field) of the wireless LAN packet format, and vice versa; converts the destination address field of the Bluetooth packet format into the destination address field (the address 1 field) of the wireless LAN packet format, and vice versa; converts the networking protocol type field of the Bluetooth packet format into the ether type field of the wireless LAN packet format, and vice versa; and converts the payload field of the Bluetooth packet format into the frame body field of the wireless LAN packet format, and vice versa. Each of the fields that are the objects of mutual conversion is a field in which actual data, such as a source address, a destination address, a format type, or payload data, are written. Once the formats of these fields are converted, then the data to be transmitted to a desired destination can be transmitted even between heterogeneous terminals. Other remaining fields contain formal information, and when necessary, the information can be generated by a receiving side. When this data is unnecessary, it can be discarded.

A process for converting a wireless LAN signal into a Bluetooth signal when a wireless LAN signal is received will now be explained. If a wireless LAN signal matches the RF layer 311 that is the lowest layer of the left-hand side branch of the wireless LAN/Bluetooth mixed protocol stack, the signal passes through this layer. The RF layer 311 in the wireless LAN protocol stack side uses the 5 GHz band for 802.11a and the 2.4 GHz band for 802.11b. The modulation method traditionally used in 802.11 is phase shift keying (PSK). Accordingly, a wireless LAN signal using one of these frequency bands and this modulation method passes through the RF layer 311. The wireless LAN signal which passes through the RF layer 311 arrives at the 802.11a/b MAC layer 312. If the wireless LAN signal matches the 802.11a/b MAC layer 312, the signal passes through this layer. Conventionally, if the MAC address loaded on the wireless LAN signal matches the MAC address of the terminal receiving the wireless LAN signal, the signal passes through the 802.11a/b MAC layer 312. Otherwise, the received signal is transmitted to a terminal having a matching MAC address. However, according to the present invention, a terminal on which a wireless LAN/Bluetooth mixed protocol stack is installed (a “wireless LAN/Bluetooth mixed terminal”). Therefore, the format of a wireless LAN signal is converted into the format of a Bluetooth signal, and even when the MAC addresses of the wireless LAN signal and the receiving terminal do not match, the signal is transferred to the conversion layer 34.

The wireless LAN signal passing through the 802.11a/b MAC layer 312 arrives at the LLC layer 313. If the wireless LAN signal matches the LLC layer 313, the signal passes through this layer. The wireless LAN signal which passes through the LLC layer 313 arrives at the conversion layer 34. If the destination of the wireless LAN signal is the wireless LAN/Bluetooth mixed terminal, the signal passes through the conversion layer and is transferred to upper layers such that an application on the terminal can obtain the data loaded on the wireless LAN signal. However, if the destination of the wireless LAN signal is another Bluetooth terminal, important information, such as the destination address, the source address, and the data, is not modified in the conversion layer and the format of the packet is converted such that the signal can be transmitted to a heterogeneous terminal without change. The wireless LAN signal (strictly speaking, before conversion, this was a wireless LAN signal, but after conversion, this is a Bluetooth signal) which is converted into a Bluetooth packet format then passes through the BNEP layer 325, the L2CAP layer 324, the HCI layer 323, the baseband layer 322, and the RF layer 321, and becomes a complete Bluetooth signal which is transmitted to the destination Bluetooth terminal. Accordingly, an environment is established in which a wireless LAN terminal can be connected to a Bluetooth terminal and can communicate with the Bluetooth terminal through a wireless LAN/Bluetooth mixed terminal.

When a Bluetooth signal is received, the process for converting the Bluetooth signal into a wireless LAN signal is the inverse of the process described above, and therefore the detailed explanation will be omitted herein.

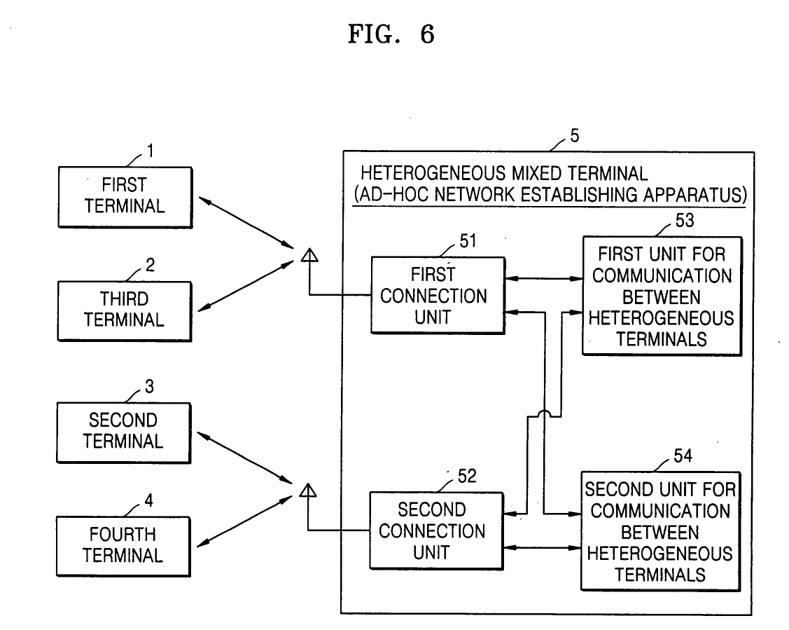

FIG. 6 is a diagram of the structure of an apparatus for establishing an ad-hoc network according to an embodiment of the present invention.

Referring to FIG. 6, an apparatus for establishing an ad-hoc network 5 includes a first connection unit 51, a second connection unit 52, a first unit for communication between heterogeneous terminals 53, and a second unit for communication between heterogeneous terminals 54. The apparatus for establishing an ad-hoc network 5 is installed in a heterogeneous mixed terminal 5.

First, a case in which a first data packet transmitted by a first terminal 1, on which a first protocol is installed, is transmitted to a second terminal 3, on which a second protocol is installed, will now be explained.

The first connection unit 51 connects the heterogeneous mixed terminal 5 to the first terminal 1. The heterogeneous mixed terminal 5 includes a single layer portion that is obtained by unifying the upper layers common to the heterogeneous protocol stacks; a double layer portion that is obtained by separating different lower layers; and a conversion layer which converts a packet formatted for one protocol stack into a packet formatted for another protocol stack, and which is disposed between the single layer portion and the double layer portion. A first protocol stack is installed on the first terminal 1. While the heterogeneous mixed terminal 5 can contain a protocol stack including a single layer portion and a double layer portion, as illustrated in FIG. 3, it could also contain single and double layer portions according to protocols other than wireless LAN or Bluetooth.

A second connection unit 52 connects the heterogeneous mixed terminal 5 to a second terminal 3, on which a second protocol stack is installed. Thus, the first terminal 1 and the second terminal 3 perform communication using different protocol stacks, respectively. That is, since the first terminal 1 and the second terminal 3 use different methods of communication, the first terminal 1 and the second terminal 3 cannot communicate directly with each other.

The first unit for communication between heterogeneous terminals 53 receives a first data packet from the first terminal 1. If the address written in the destination address field included in the first data packet is not the address of the heterogeneous mixed terminal, that is, if the destination of the first data packet is not the heterogeneous mixed terminal 5, the first protocol stack packet format of the first data packet is converted into the second protocol stack packet format in the conversion layer, and the first data packet converted into the second protocol stack packet format is transmitted to the connected second terminal 3. If the address written in the destination address field included in the first data packet is the address of the heterogeneous mixed terminal, that is, if the destination of the first data packet is the heterogeneous mixed terminal 5, the first data packet is transferred to the single layer of the heterogeneous mixed protocol stack. The heterogeneous mixed terminal does not only relay information to heterogeneous terminals, but also functions as an independent terminal with its own address. Accordingly, if the destination of the first data packet is the heterogeneous mixed terminal 5, the received data packet is transferred to the highest layer such that the packet can be processed appropriately to its purpose. If the destination of the first data packet is not the heterogeneous mixed terminal 5, the first protocol stack packet format of the first data packet is converted into the second protocol stack packet format in the conversion layer and the first data packet converted into the second protocol stack packet format is transmitted to the connected second terminal 3. Here, the first protocol stack packet format means a packet format matching the first protocol stack, and the second protocol stack packet format means a packet format matching the second protocol stack. Since heterogeneous protocol stacks use packet formats different from each other, in order for heterogeneous terminals to communicate with each other, transmitted formats must be converted into formats useable by receiving terminals.

Next, a case in which a first data packet, transmitted by a fourth terminal 4, is transmitted to the heterogeneous mixed terminal 5 or to a third terminal 2 will now be explained.

A first protocol stack is installed on the third terminal 2 and a second protocol stack is installed on the fourth terminal 4. The first connection unit 1 connects the heterogeneous mixed terminal 5 and the third terminal 2. The second connection unit 2 connects the heterogeneous mixed terminal 5 and the fourth terminal 4.

The second unit for communication between heterogeneous terminals 54 receives a second data packet from the connected fourth terminal 4. If the address written in the destination address field included in the second data packet is not the address of the heterogeneous mixed terminal 5, that is, if the destination of the second data packet is not the heterogeneous mixed terminal 5, the second protocol stack packet format of the second data packet is converted into the first protocol stack packet format in the conversion layer, and the data packet converted into the first protocol stack packet format is transmitted to the connected third terminal 2. If the address written in the destination address field included in the second data packet is the address of the heterogeneous mixed terminal, that is, if the destination of the second data packet is the heterogeneous mixed terminal 5, the second data packet is transferred to the single layer portion of the heterogeneous mixed protocol stack.

Generally, when communication methods mainly used at present are considered, the first protocol stack will be a wireless LAN protocol stack; the second protocol stack will be a Bluetooth protocol stack; the first terminal 1 and the third terminal 2 will be wireless LAN terminals; the second terminal 2 and the fourth terminal 4 will be Bluetooth terminals; and the heterogeneous mixed terminal will be a wireless LAN/Bluetooth mixed terminal. In this case, the first connection unit 51 connects the wireless LAN/Bluetooth mixed terminal 5, the first terminal 1 and the third terminal 2, according to the scanning, authorization, and association processes of the IEEE 802.11 standard. When a wireless LAN terminal (a station in the IEEE 802.11 standard) wants to connect with the wireless LAN/Bluetooth mixed terminal, the wireless LAN terminal needs to obtain connection information, such as synchronization information, from the wireless LAN/Bluetooth mixed terminal.

According to the IEEE 802.11 standard, either of the following two methods can be used to connect the wireless LAN terminal and the wireless LAN/Bluetooth mixed terminal. First, in a passive scanning method, in order to establish an ad-hoc network, the wireless LAN/Bluetooth mixed terminal sets independent basic service set (IBSS) mod3, and periodically transmits a beacon frame containing connection information such as synchronization information. The wireless LAN terminal waits to receive the beacon frame periodically transmitted by the wireless LAN/Bluetooth mixed terminal. If the wireless LAN terminal receives the beacon frame, it connects with the wireless LAN/Bluetooth mixed terminal by using connection information included in the beacon frame. Second, in an active scanning method, the wireless LAN terminal tries to connect with the wireless LAN/Bluetooth mixed terminal, by transmitting a probe request frame. If the probe request frame is received, the wireless LAN/Bluetooth mixed terminal transmits a probe response frame containing connection information, such as synchronization information. If the wireless LAN terminal receives the probe response frame, the wireless LAN terminal connects with the wireless LAN/Bluetooth mixed terminal by using the connection information included in the probe response frame. Through the authorization and association processes and others, the wireless LAN terminal and the wireless LAN/Bluetooth mixed terminal can communicate data packets with each other.

The second connection unit 52 connects the wireless LAN/Bluetooth mixed terminal 5, the second terminal 3, and the fourth terminal 4, according to the personal area network (PAN) profile process of the Bluetooth standard. A profile is a rule for using the Bluetooth protocol stack in a terminal, and PAN profile defines a rule on IP traffic. By using the PAN profile, an ad-hoc network can be established. According to the Bluetooth standard, any one of a number of Bluetooth terminals can lead trials for connection. When connected, the terminal which led the connection becomes a master and the terminal or terminals which are passively connected becomes slaves. At this time, if a transmitting Bluetooth terminal knows the address of a receiving Bluetooth terminal in advance, a trial to establish a connection is performed by transmitting a page message. If the address is not known in advance, a trial to establish a connection is performed by transmitting an inquiry message (mores strictly speaking, a baseband inquiry message).

By using these messages, it is confirmed whether or not there is a Bluetooth terminal around the transmitting terminal, and if it is confirmed that there is a Bluetooth terminal, by using SDP, it is confirmed whether or not this Bluetooth terminal provides a PAN profile. Since a wireless LAN/Bluetooth mixed terminal provides a PAN profile, according to a procedure written in the PAN profile, the L2CAP channel is initialized, and BNEP commands are transmitted and received such that the BNEP layer is connected.

Once a connection is established through the process described above, if the wireless LAN/Bluetooth mixed terminal desires to receive a data packet from a Bluetooth terminal, the Bluetooth terminal transmitting the data packet should be a master and the wireless LAN/Bluetooth mixed terminal receiving a data packet should be a slave. Accordingly, master/slave switching should be performed.

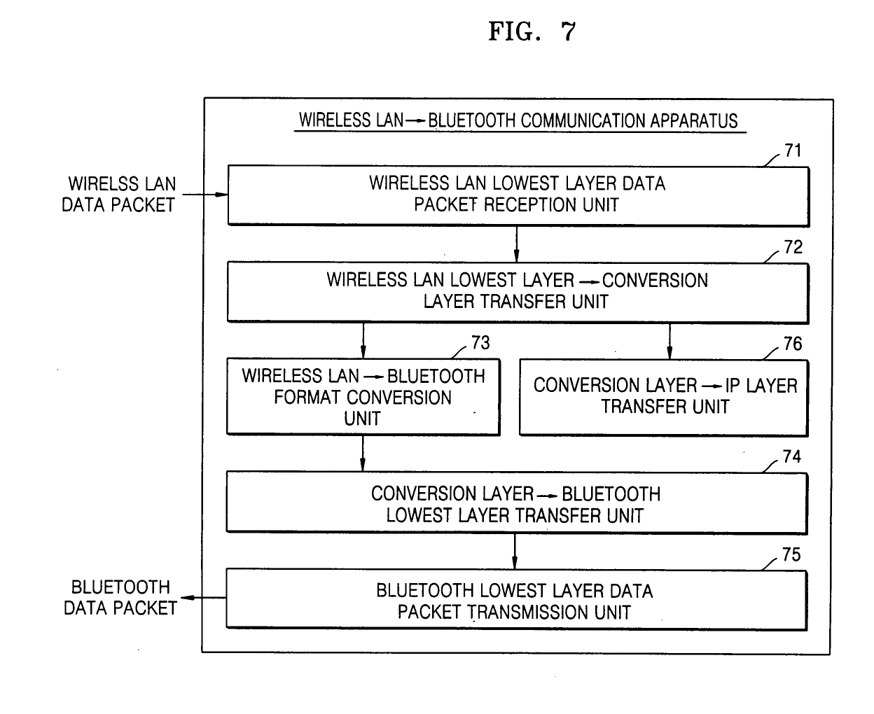

FIG. 7 is a diagram of the structure of a wireless LAN→Bluetooth communication apparatus according to an embodiment of the present invention.

Referring to FIG. 7, the wireless LAN→Bluetooth communication apparatus includes a wireless LAN lowest layer data packet reception unit 71, a wireless LAN lowest layer→conversion layer transfer unit 72, a wireless LAN→Bluetooth format conversion unit 73, a conversion layer→Bluetooth lowest layer transfer unit 74, a Bluetooth lowest layer data packet transmission unit 75, and a conversion layer→IP layer transfer unit 76. The wireless LAN→Bluetooth communication apparatus receives a wireless LAN data packet, and processes it by itself or converts it into a Bluetooth data packet to be transmitted to a Bluetooth terminal.

As previously described, the wireless LAN/Bluetooth mixed protocol stack includes a single layer portion that is obtained by unifying upper layers common to the wireless LAN protocol stack and the Bluetooth protocol stack; a double layer portion that is obtained by separating different lower layers; and a conversion layer which converts a wireless LAN packet format into a Bluetooth packet format, and vice versa and which is disposed between the single layer portion and the double layer portion. The wireless LAN lowest layer data packet reception unit 71 receives a wireless LAN data packet at the lowest layer in the wireless LAN protocol stack side as an input end. That is, it receives the data packet transmitted by the wireless LAN terminal with the RF layer of the wireless LAN protocol stack side as an input end.

The wireless LAN lowest layer-conversion layer transfer unit 72 then transfers the received data packet to the conversion layer. In the conversion layer, it is determined whether the data packet is transferred to the upper layers or whether the packet format is converted and transmitted to an external Bluetooth terminal. Accordingly, once a received data packet matches all the layers, such as the LLC layer, that the packet should pass through, all received data packets are transferred to the conversion layer. That is, a data packet received in the RF layer of the wireless LAN protocol stack side arrives at the conversion layer through the 802.11a/b MAC and LLC layers.

If the MAC address written in the destination address field included in the data packet transferred to the conversion layer is not the MAC address of the wireless LAN/Bluetooth mixed terminal on which the wireless LAN/Bluetooth mixed protocol stack is installed, the wireless LAN→Bluetooth packet format conversion unit 73 converts the wireless LAN packet format of the data packet into the Bluetooth packet format in the conversion layer. In the present invention, since a destination is determined by using a MAC address that is not a software-driven IP address, but a hardware address, it can be processed by hardware without referring to the network layer of the OSI reference model, and accordingly, the entire processing speed can be increased and the load on the system can be reduced.

Packet format conversion from wireless LAN to Bluetooth will now be explained in more detail. Referring to FIGS. 4 and 5, the source address field (the address 2 field shown in FIG. 4) of the wireless LAN packet format is converted into the source address field of the Bluetooth packet format. The destination address field (the address 1 field shown in FIG. 4) of the wireless LAN packet format is converted into the destination address field of the Bluetooth packet format. The ether type field of the wireless LAN packet format is converted into the networking protocol type field of the Bluetooth packet format. The frame body field of the wireless LAN packet format is converted into the payload field of the Bluetooth packet format.

The conversion layer→Bluetooth lowest layer transfer unit 74 transfers the data packet, which has been converted into the Bluetooth packet format in the conversion layer, to the lowest layer of the Bluetooth protocol stack side in the double layer of the wireless LAN/Bluetooth mixed protocol stack through the upper layers of the Bluetooth protocol stack. That is, the data packet is transferred from the conversion layer to the RF layer through the BNEP, L2CAP, HCI, and baseband layers.

The Bluetooth lowest layer data packet transmission unit 75 then transmits the data packet. That is, the packet in the form of a Bluetooth signal is transmitted to the outside using the 2.4 GHz band, frequency hopping method, G-FSK method, and TDD method.

Returning to the originally received wireless LAN data packet transferred to the conversion layer, if the MAC address written in the destination address field included in the data packet is the MAC address of the wireless LAN/Bluetooth mixed terminal, the conversion layer→IP layer transfer unit 76 transfers the data packet to the IP layer that is the lowest layer of the single layer portion of the wireless LAN/Bluetooth mixed protocol stack. Thereafter, data packet transferred to the IP layer arrives at the corresponding application through the TCP/UDP and socket layers and is processed appropriately to its purpose.

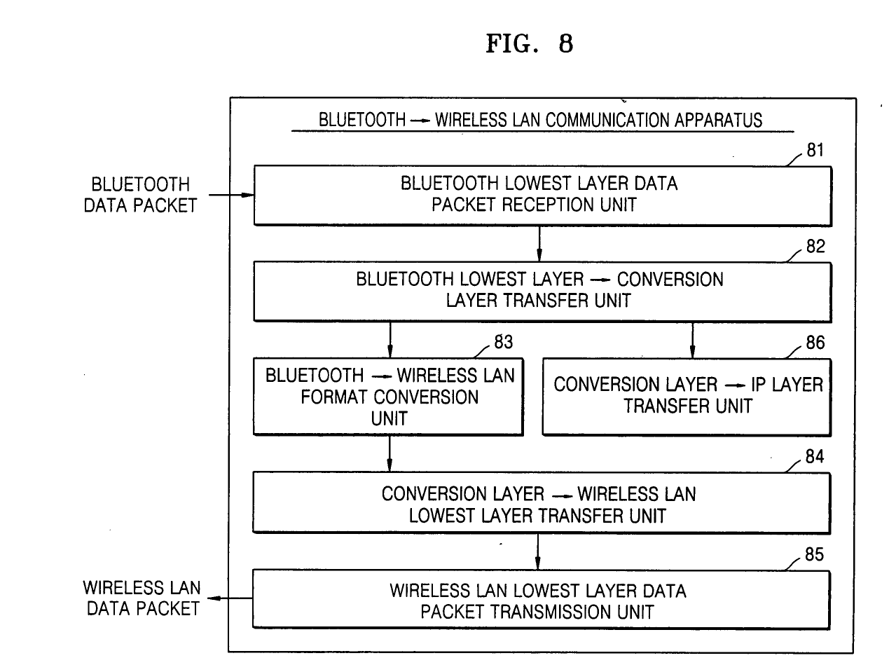

FIG. 8 is a diagram of the structure of a Bluetooth→wireless LAN communication apparatus according to an embodiment of the present invention.

Referring to FIG. 8, the Bluetooth→wireless LAN communication apparatus includes a Bluetooth lowest layer data packet reception unit 81, a Bluetooth lowest layer-conversion layer transfer unit 82, a Bluetooth→wireless LAN format conversion unit 83, a conversion layer→wireless LAN lowest layer transfer unit 84, a wireless LAN lowest layer data packet transmission unit 85, and a conversion layer→IP layer transfer unit 86. The Bluetooth→wireless LAN communication apparatus receives a Bluetooth data packet and processes it by itself or converts into a wireless LAN data packet to be transmitted to a wireless LAN terminal.

In the double layer portion of the wireless LAN/Bluetooth mixed protocol stack, the Bluetooth lowest layer data packet reception unit 81 receives a data packet in the lowest layer in the Bluetooth protocol stack side as an input end. That is, it receives the data packet transmitted by the Bluetooth terminal in the RF layer of the Bluetooth protocol stack side as an input end.

The Bluetooth lowest layer→conversion layer transfer unit 82 then transfers the received data packet to the conversion layer. In the conversion layer, it is determined whether the data packet is transferred to the upper layers or whether the packet format is converted and transmitted to an external wireless LAN terminal. Accordingly, once a received data packet matches all the layers, such as the BNEP layer, that the packet should pass through, the received data packet is transferred to the conversion layer. That is, a data packet received in the RF layer of the Bluetooth protocol stack side as an input end arrives at the conversion layer through the baseband, HCI, L2CAP, and BNEP layers.

If the MAC address written in the destination address field included in the data packet transferred to the conversion layer is not the MAC address of the wireless LAN/Bluetooth mixed terminal on which the wireless LAN/Bluetooth mixed protocol stack is installed, the Bluetooth→wireless LAN packet format conversion unit 83 converts the Bluetooth packet format of the data packet into the wireless LAN packet format in the conversion layer. As described above, since a destination is determined by using a MAC address that is not a software-driven IP address, but a hardware address, it can be processed by hardware without referring to the network layer of the OSI reference model, and accordingly, the entire processing speed can be increased and the load on the system can be reduced.

Packet format conversion from Bluetooth to wireless LAN will now be explained in more detail. Referring to FIGS. 4 and 5, the source address field of the Bluetooth packet format is converted into the source address field (the address 2 field shown in FIG. 4) of the wireless LAN packet format. The destination address field of the Bluetooth packet format is converted into the destination address field (the address 1 field shown in FIG. 4) of the wireless LAN packet format. The networking protocol type field of the Bluetooth packet format is converted into the ether type field of the wireless LAN packet format. The payload field of the Bluetooth packet format is converted into the frame body field of the wireless LAN packet format.

The conversion layer-wireless LAN lowest layer transfer unit-84 transfers the data packet which has been converted into the wireless LAN packet format in the conversion layer, to the lowest layer of the wireless LAN protocol stack side in the double layer of the wireless LAN/Bluetooth mixed protocol stack through the upper layers of the wireless LAN protocol stack. That is, the data packet is transferred from the conversion layer arrives to the RF layer through the LLC and 802.11a/b MAC layers.

The wireless LAN lowest layer data packet transmission unit 85 then transmits the data packet. That is, the packet, in the form of a wireless LAN signal, is transmitted to the outside using the 2.4 GHz band, binary phase shift keying (BPSK), quadrature phase shift keying (QPSK), 16-quadrature amplitude modulation (QAM), and 64-orthogonal frequency division multiplexing (OFDM).

Returning to the originally received Bluetooth packet transferred to the conversion layer, if the MAC address written in the destination address field included in the data packet is the MAC address of the wireless LAN/Bluetooth mixed terminal, the conversion layer-IP layer transfer unit 86 transfers the data packet to the IP layer that is the lowest layer of the single layer portion of the wireless LAN/Bluetooth mixed protocol stack. Thereafter, the data packet transferred to the IP layer arrives at the corresponding application through the TCP/UDP, and socket layers, and is processed appropriately to its purpose.

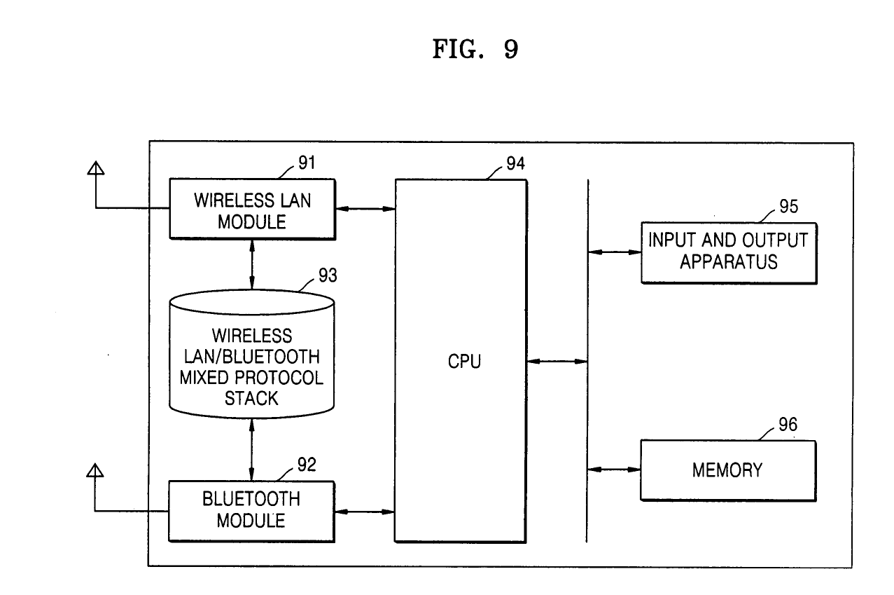

FIG. 9 is a diagram showing an implemented model of a wireless LAN/Bluetooth mixed terminal.

Referring to FIG. 9, the implemented model of the wireless LAN/Bluetooth mixed terminal includes a wireless LAN module 91, a Bluetooth module 92, a wireless LAN/Bluetooth mixed protocol stack 93, a CPU 94, an input and output apparatus 95, and a memory 96.

The wireless LAN module 91 has an embedded element which enables the wireless LAN/Bluetooth mixed terminal to operate a wireless LAN terminal. The Bluetooth module 92 has an embedded element which enables the wireless LAN/Bluetooth mixed terminal to operate a Bluetooth terminal. In the wireless LAN/Bluetooth mixed protocol stack 93, the protocol stack shown in FIG. 3 is stored. The CPU 94 controls the wireless LAN module 91 and the Bluetooth module 92, and processes received data packets. The input and output apparatus 95 receives data from a user and transfers the data to the CPU 94, or if data to be output to the user is included in a data packet, the input and output apparatus 95 receives the data from the CPU 94 and outputs it to the user. The memory 96 receives data from the CPU 94 and stores the data.

Through the respective organic operations of the elements described above, the apparatus for establishing an ad-hoc network, the wireless LAN-Bluetooth communication apparatus, and the Bluetooth-wireless LAN communication apparatus according to exemplary embodiments of the present invention are implemented.

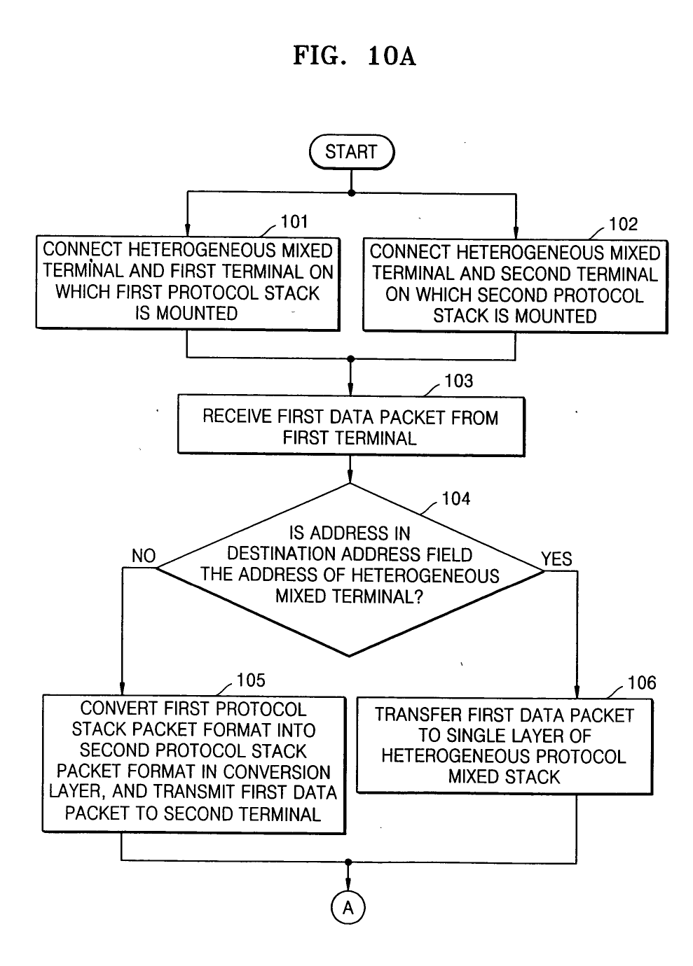

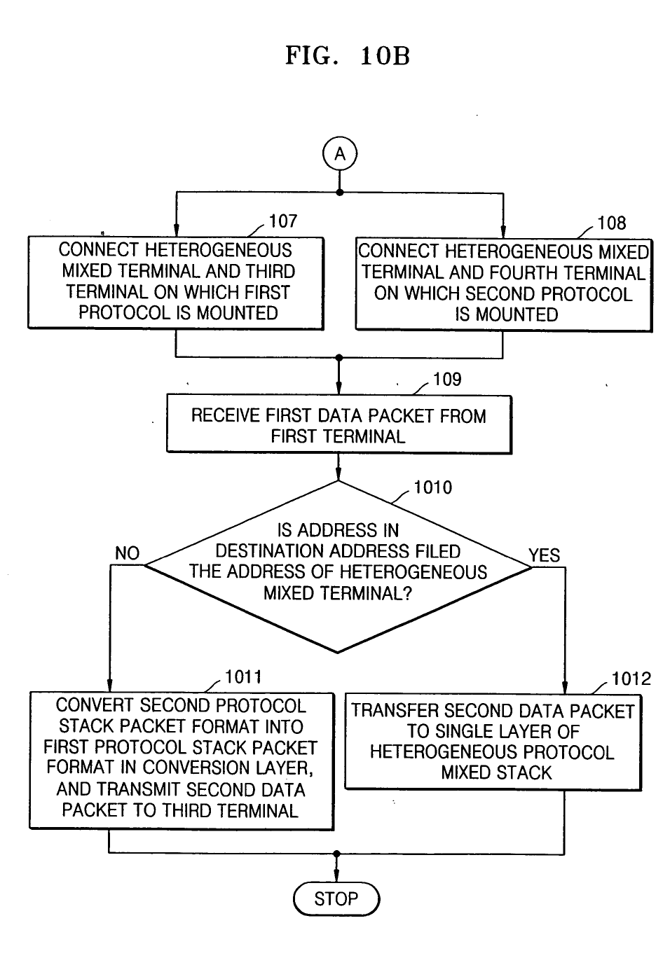

FIGS. 10A and 10B are flowcharts of the steps performed according to a method for establishing an ad-hoc network according to an embodiment of the present invention.

Referring to FIGS. 10A and 10B, a method for establishing an ad-hoc network will now be explained.

First, a case, in which a first data packet, transmitted by a first terminal on which a first protocol is installed, is transmitted to a heterogeneous terminal or to a second terminal on which a second protocol is installed, will now be explained.

The heterogeneous mixed terminal includes a single layer portion obtained by unifying upper layers common to heterogeneous protocol stacks, a double layer portion obtained by separating different lower layers, and a conversion layer which converts a packet formatted for one protocol stack into a packet formatted for another protocol stack and which is disposed between the single layer portion and the double layer portion. In step 101, the heterogeneous mixed terminal is connected to a first terminal, on which a first protocol stack is installed. In step 102, the heterogeneous mixed terminal is connected to a second terminal, on which a second protocol stack is installed. A first data packet from the first terminal is received in step 103. If the address written in the destination address field included in the first data packet is not the address of the heterogeneous mixed terminal in step 104, the first protocol stack packet format of the first data packet is converted into the second protocol stack packet format in the conversion layer, and the first data packet having been converted into the second protocol stack packet format is transmitted to the connected second terminal in step 105. If the address written in the destination address field included in the first data packet is the address of the heterogeneous mixed terminal in step 104, the first data packet is transferred to the single layer portion of the heterogeneous mixed protocol stack in step 106.

Next, a case in which a first data packet, transmitted by a fourth terminal on which a second protocol is installed, is transmitted to a heterogeneous mixed terminal or to a third terminal, on which a first protocol stack t is installed will now be explained.

The heterogeneous mixed terminal is connected to the third terminal, on which the first protocol stack is installed, in step 107. The heterogeneous mixed terminal is connected to the fourth terminal, on which a second protocol stack is installed, in step 108. Then, the second data packet from the connected fourth terminal is received in step 109.

If the address written in the destination address field included in the second data packet is not the address of the heterogeneous mixed terminal in step 1010, then the second protocol stack packet format of the second data packet is converted into the first protocol stack packet format in the conversion layer, and the data packet having been converted into the first protocol stack packet format is transmitted to the connected third terminal in step 1011. If the address written in the destination address field included in the second data packet is the address of the heterogeneous mixed terminal, then the second data packet is transferred to the single layer portion of the heterogeneous mixed protocol stack in step 1012.

According to this embodiment, if the first protocol stack is a wireless LAN protocol stack, the second protocol stack is a Bluetooth protocol stack, the first terminal and the third terminal are wireless LAN terminals, the second terminal and the fourth terminal are Bluetooth terminals, and the heterogeneous mixed terminal is a wireless LAN/Bluetooth mixed terminal, the heterogeneous mixed terminal and the first terminal are connected according to the scanning, authorization, and association processes of the IEEE 802.11 standard in the step 101; the heterogeneous mixed terminal and the second terminal are connected according to the PAN profile process of the Bluetooth standard in the step 102; the heterogeneous mixed terminal and the third terminal are connected according to the scanning, authorization, and association processes of the IEEE 802.11 standard in the step 107; and the heterogeneous mixed terminal and the fourth terminal are connected according to the PAN profile process of the Bluetooth standard in the step 108.

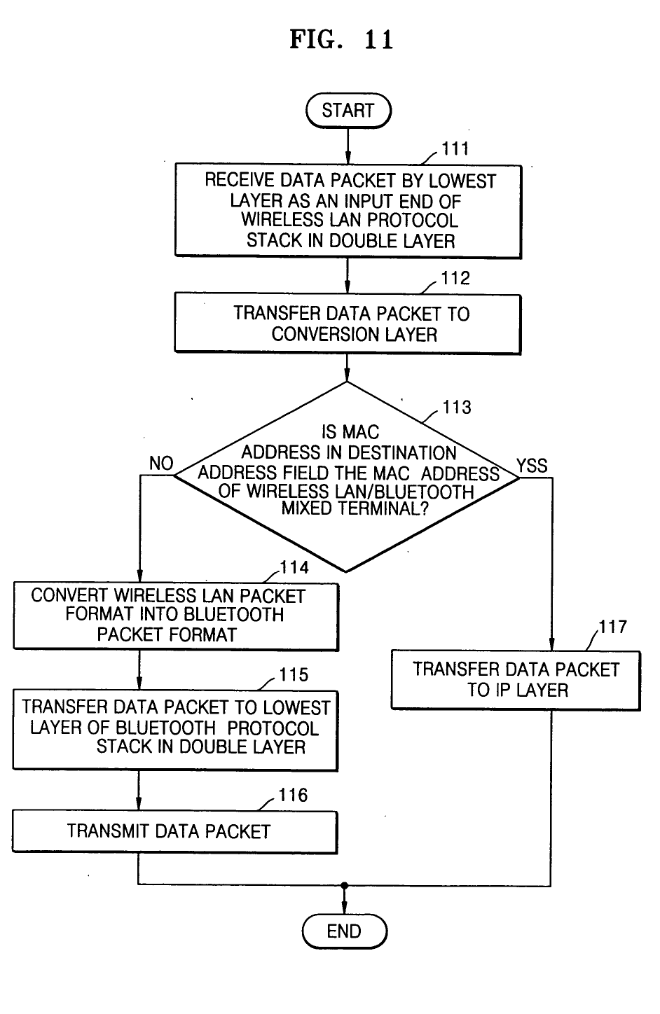

FIG. 11 is a flowchart of the steps performed by a method for wireless LAN→Bluetooth communications according to an embodiment of the present invention.

Referring to FIG. 11, the wireless LAN→Bluetooth communication method will now be explained.

In the double layer portion of the wireless LAN/Bluetooth mixed protocol stack, a data packet is received in the lowest layer of the wireless LAN protocol stack side as an input end in step 111. Then, the received data packet is transferred to the conversion layer in step 112. If the MAC address written in the destination address field included in the data packet transferred to the conversion layer is not the MAC address of the wireless LAN/Bluetooth mixed terminal on which the wireless LAN/Bluetooth mixed protocol stack is mounted in step 113, the wireless LAN packet format of the data packet is converted into the Bluetooth packet format in the conversion layer in step 114. At this time, the source address field of the wireless LAN packet format is converted into the source address field of the Bluetooth packet format. The destination address field of the wireless LAN packet format is converted into the destination address field of the Bluetooth packet format. The ether type field of the wireless LAN packet format is converted into the networking protocol type field of the Bluetooth packet format. The frame body field of the wireless LAN packet format is converted into the payload field of the Bluetooth packet format.

Then, the data packet having been converted into the Bluetooth packet format in the conversion layer, is transferred to the lowest layer of the Bluetooth protocol stack side in the double layer portion of the wireless LAN/Bluetooth mixed protocol stack in step 115. Then, the data packet is transmitted by the lowest layer as an output end in step 116. If the MAC address written in the destination address field included in the data packet is the MAC address of the wireless LAN/Bluetooth mixed terminal in step 113, the data packet is transferred to the IP layer that is the lowest layer of the single layer of the wireless LAN/Bluetooth mixed protocol stack in step 117.

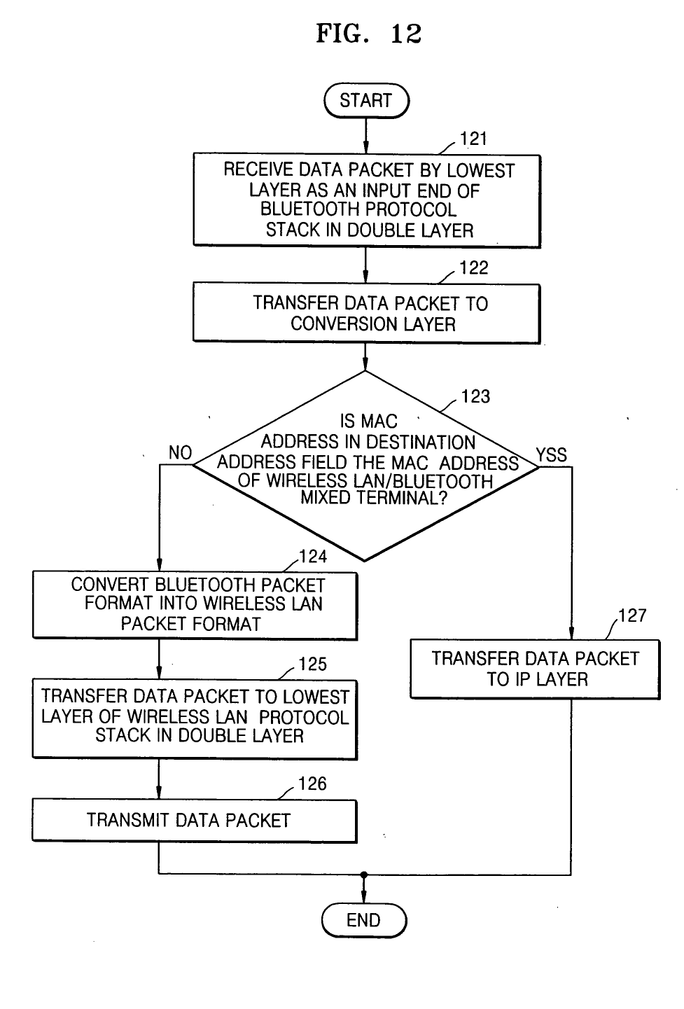

FIG. 12 is a flowchart of the steps performed by a method for Bluetooth→wireless LAN communications according to an embodiment of the present invention.

Referring to FIG. 12, the Bluetooth→wireless LAN communication method will now be explained.

In the double layer portion of the wireless LAN/Bluetooth mixed protocol stack, a data packet is received in the lowest layer of the Bluetooth protocol stack side as an input end in step 121. Then, the received data packet, is transferred to the conversion layer in step 122. If the MAC address written in the destination address field included in the data packet transferred to the conversion layer is not the MAC address of the wireless LAN/Bluetooth mixed terminal on which the wireless LAN/Bluetooth mixed protocol stack is installed in step 123, then, the Bluetooth packet format of the data packet is converted into the wireless LAN packet format in the conversion layer in step 124. At this time, the source address field of the Bluetooth packet format is converted into the source address field of the wireless LAN packet format. The destination address field of the Bluetooth packet format is converted into the destination address field of the wireless LAN packet format. The networking protocol type field of the Bluetooth packet format is converted into the ether type field of the wireless LAN packet format. The payload field of the Bluetooth packet format is converted into the frame body field of the wireless LAN packet format. Then, the data packet which has been converted into the wireless LAN packet format in the conversion layer, is transferred to the lowest layer of the wireless LAN protocol stack side in the double layer portion of the wireless LAN/Bluetooth mixed protocol stack in step 125. Next, the data packet w is transmitted by the lowest layer as an output end in step 126. If the MAC address written in the destination address field included in the data packet is the MAC address of the wireless LAN/Bluetooth mixed terminal in step 123, the data packet is transferred to the IP layer that is the lowest layer of the single layer portion of the wireless LAN/Bluetooth mixed protocol stack in step 127.

According to an aspect of the present invention, heterogeneous terminals that cannot conventionally communicate with each other are relayed such that communications between the heterogeneous terminals are enabled. By enabling this communication between heterogeneous terminals, an ad-hoc network in which a plurality of heterogeneous terminals can freely communicate with each other can be established. More specifically, by relaying a wireless LAN terminal and a Bluetooth terminal, which are representative heterogeneous terminals, according to the present invention, communications between the wireless LAN terminal and the Bluetooth terminal are enabled, and an ad-hoc network, in which a plurality of wireless LAN terminals and a plurality of Bluetooth terminals can freely communicate with each other, can be established. In particular, since a destination is determined by using a MAC address that is a hardware address and not a software-driven IP address, the address can be processed by hardware without referring to the network layer of the OSI reference model. Accordingly, processing speed can be increased and the load on the system can be reduced.

According to an aspect of the present invention, the above-described embodiments can be written as computer programs and can be implemented in general-use computers that execute the programs from a computer readable recording medium.

The structure of data as described in the above embodiments of the present invention can be recorded on a computer readable recording medium through a variety of means.

Examples of the computer readable recording medium can include, but are not limited to: magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by those of ordinary skill in the art that the present invention should not be limited to the described exemplary embodiments, but that various changes and modifications may be made thereto without departing from the spirit and scope of the present invention. The described embodiments should be considered as descriptive only and not for purposes of limitation. Therefore, the scope of the present is not limited to the described range of the appended claims.

1. A method of establishing an ad-hoc network comprising:
accessing a first terminal on which a first protocol stack is installed;
accessing a second terminal on which a second protocol stack is installed;
receiving a data packet, formatted for the first protocol stack, from the first terminal;
converting the format of the received data packet to the format of the second protocol stack; and
transmitting the converted data packet to the second terminal.

2. The method of claim 1, further comprising:
determining if the address written in a destination address field included in the data packet is the address of an apparatus performing the method of establishing an ad-hoc network;
wherein if the address written in the destination address field included in the data packet is not the address of the apparatus performing the method of establishing an ad-hoc network, the converting is performed.

3. The method of claim 1, further comprising:
determining if the address written in a destination address field included in the data packet is the address of an apparatus performing the method of establishing an ad-hoc network; and
if the address written in the destination address field included in the data packet is the address of the apparatus performing the method of establishing an ad-hoc network, transferring the data packet to an upper later of a protocol stack installed on the apparatus performing the method of establishing an ad-hoc network.

4. The method of claim 1, wherein the first protocol stack is a wireless local area network (LAN) protocol stack, and the second protocol stack is a Bluetooth protocol stack.

5. The method of claim 4, wherein in accessing the first terminal, the accessing is performed according to the scanning, authentication, and combining processes of the IEEE 802.11 standard.

6. The method of claim 4, wherein in accessing the second terminal, the accessing is performed according to a personal area network (PAN) profile process of the Bluetooth standard.

7. A method of communication between heterogeneous protocols comprising:
receiving a data packet in the lowest layer of a first protocol stack;
transferring the received data packet to a conversion layer; and
converting a first protocol packet format of the data packet transferred to the conversion layer into a second protocol packet format.

8. The method of claim 7, further comprising:
determining if the media access control (MAC) address written in a destination address field included in the data packet is the MAC address of an apparatus performing the method of communication;
if the MAC address written in the destination address field included in the data packet is not the MAC address of the apparatus performing the method of communication, the converting is performed.

9. The method of claim 7, wherein in converting the packet format,
the source address field of the first protocol packet format is converted into the source address field of the second protocol packet format, and
the destination address field of the first protocol packet format is converted into the destination address field of the second protocol packet format.

10. The method of claim 7, further comprising:
transferring the data packet converted into the second protocol packet format to the lowest layer of a second protocol stack; and
transmitting the data packet transferred to the lowest layer of the second protocol stack.

11. The method of claim 7, wherein
the first protocol stack is a Bluetooth protocol stack,
the first protocol packet format is a Bluetooth packet format, and
the second protocol packet format is a wireless LAN packet format.

12. The method of claim 11, wherein in converting the packet format,
a networking protocol type field of the Bluetooth packet format is converted into an ether type field of the wireless LAN packet format, and
a payload field of the Bluetooth packet format is converted into a frame body field of the wireless LAN packet format.

13. The method of claim 11, further comprising:
if the MAC address written in the destination address field included in the data packet transferred to the conversion layer is the MAC address of the apparatus performing the method of communication, transferring the data packet to the IP layer of a protocol stack mounted on the apparatus performing method of communication.

14. A mixed protocol stack comprising:
a single layer portion which is obtained by unifying upper layers common to a first protocol stack and a second protocol stack;
a double layer portion which is obtained by separating lower layers which differ between the first protocol stack and the second protocol stack; and
a conversion layer which converts the format of a data packet between a first protocol packet format and a second protocol packet format and which is disposed between the single layer portion and the double layer portion.

15. The mixed protocol stack of claim 14, wherein the single layer portion comprises an Internet protocol (IP)layer, a transmission control protocol (TCP)/user datagram protocol (UDP) layer, and a socket layer stacked in order from the bottom.

16. The mixed protocol stack of claim 14, wherein
the first protocol stack is a wireless LAN protocol stack,
the second protocol stack is a Bluetooth protocol stack,
the first protocol packet format is a wireless LAN packet format, and
the second protocol packet format is a Bluetooth packet format.

17. The mixed protocol stack of claim 16, wherein
the double layer portion is divided into a Bluetooth protocol stack side and a wireless LAN protocol stack side;
the wireless LAN protocol stack side comprises a radio frequency (RF)layer, an IEEE 802.11a/b MAC layer, and a logical link control (LLC) layer, stacked in order from the bottom; and
the Bluetooth protocol stack side comprises an RF layer, a baseband layer, a host controller interface (HCI)layer, a logical link control and adaptation protocol (L2CAP) layer, and a Bluetooth network encapsulation protocol (BNEP) layer, stacked in order from the bottom.

18. A computer readable recording medium having thereon a computer program for a method of establishing an ad-hoc network, wherein the method comprises:
accessing a first terminal on which a first protocol stack is installed;
accessing a second terminal on which a second protocol stack is installed;
receiving a data packet, formatted for the first protocol stack, from the first terminal;
converting the format of the received data packet to the format of the second protocol stack; and
transmitting the converted data packet to the second terminal.

19. A computer readable recording medium having thereon a computer program for a method of communications between heterogeneous protocols, the method comprising:
receiving a data packet in the lowest layer of a first protocol stack;
transferring the received data packet to a conversion layer; and
converting a first protocol packet format of the data packet transferred to the conversion layer into a second protocol packet format.
